(19) United States
(12) Patent Application Publication
(10) Pub. No.: US 2004/0190145 A1
(43) Pub. Date: Sep. 30, 2004

(54) Mirror angle gauge

(76) Inventor: Henry Oloff, Spartanburg, SC (US)

Correspondence Address: ROBERTSON & MULLINAX, LLC, PO BOX 26029, GREENVILLE, SC, 29616-1029, US

(21) Appl. No.: 10/403,717

(22) Filed: Mar. 31, 2003

(51) Int. Cl. G02B 27/08

(52) U.S. Cl. 359/616

(57) ABSTRACT

A mirror gauge is provided for holding hinged mirrors in one of a plurality of selectable, predetermined angles. The mirror gauge facilitates use of the mirrors in the visualization of repeating patterns useful in quilting, fabric design, and related uses. The mirror gauge provides for channels which hold the mirrors in predetermined angles of 90 degrees, 60 degrees, and 45 degrees, etc.

### FIELD OF THE INVENTION

This invention is directed towards a mirror angle gauge designed to hold a hinged mirror at a predetermined angle.

### BACKGROUND OF THE INVENTION

This invention relates to hinged or adjacent mirrors which are held at an angled, spaced-apart distance so as to form a repeating reflection of a single design motif. The use of angled mirrors to form repeating geometric designs and patterns is known within the kaleidoscope art. U.S. Pat. No. 169,882 to Adams sets forth a kaleidoscope having angled mirrors joined along a hinge which forms a repeating reflected pattern within the mirrors.

U.S. Pat. No. 718,326 to Diem provides for a kaleidoscope having hinged mirrors supported along a top mirror surface by an arcuate bar defining a series of notches. The notches interact with the edges of an attached lip placed along a mirror edge. The bar with notches is used to position the mirror to obtain the indicated number of repeating patterns for an item placed in front of the hinged mirrors.

U.S. Pat. No. 3,357,768 to Cox discloses an apparatus for viewing rug color patterns based upon a small sample of material. Hinged mirrors are adjusted so as to vary the angle to allow for samples placed between the pair of mirrors to be reflected in a repeating pattern. The angle between the mirrors is adjusted to correspond to written indicia indicating whether oval, square, star, or round patterns are desired. Visible indicia lines are used to line up the mirrors at proper angles.

While it is known in the art to use angled mirrors to visualize repeating patterns, the prior art does not provide for a separate template which will physically position and retain a mirror in one of several selected angles so as to facilitate the construction of a repeating fabric design in a pattern such as a quilt. Accordingly, there remains room for variation and improvement within the art.

### SUMMARY OF THE INVENTION

It is one aspect of at least one of the present embodiments of the invention to provide for a mirror angle gauge having a plurality of defined channels for holding a hinged mirror at a pre-selected viewing angle.

It is yet another aspect of at least one of the present embodiments of the invention to provide a transparent plastic angle gauge which defines a series of receiving areas which provide pre-selected angles for holding a mirror at the desired angle.

It is yet another aspect of at least one of the present embodiments of the invention to provide an angle gauge for a mirror which facilitates the use of an angled mirror to preview a fabric pattern or motif and to permit visualization of repeating designs and patterns.

It is yet another aspect of at least one of the present embodiments to provide an angle gauge for a mirror which allows the mirror to be repositioned along a surface without disengaging the mirror from the angle gauge.

It is yet another aspect of at least one of the present embodiments to provide an angle gauge for hinged mirrors which may be easily installed upon and removed from the mirrors and requires no modification or changes to the hinged mirrors in order to be used.

It is yet another aspect of at least one of the present embodiments to provide an apparatus and process for using hinged mirrors which may be positioned at a predetermined angle for viewing a repeating pattern based upon a design positioned within the included angle observation area of the hinged mirrors.

These and other aspects of one or more of the present embodiments may be seen in reference to a gauge for holding a hinged mirror at a desired angle having a template having a surface defining a plurality of channels, a first channel and a second channel intersecting to form an angle, each of the channels adapted for engaging a respectve edge of a hinged mirror, thereby positioning the hinged mirrors at an angle defined by the channels.

In one embodiment of the invention, the first and the second channels form a 90° angle. Additionally, the template surface may define other channels to provide viewing angles, by way of example, of 45° and 60° for the hinged mirrors. The various viewing angles may be provided by multiple channels defined within a single gauge.

These and other features, aspects, and advantages of the present invention will become better understood with reference to the following description and appended claims.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings.

FIG. 1 is perspective view of a hinged mirror positioned in channels defined within a surface of a mirror gauge.

FIG. 2 is a perspective view of the hinged mirror showing the mirror gauge detached from the upper edge surface of the hinged mirror.

FIG. 3 illustrates the hinged mirror in a closed or folded position.

FIG. 4 is a perspective view of a mirror angle gauge corresponding to the present invention illustrating an engaging surface defining a plurality of channels.

FIG. 5 is a perspective view of an alternative embodiment of a mirror angle gauge.

### DESCRIPTION OF THE PREFERRED EMBODIMENT

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers may be used throughout to describe the same material, apparatus or process pathway. To avoid redundancy, detailed descriptions of much of the apparatus once described in relation to a figure is not repeated in the descriptions of subsequent figures, although such apparatus or process may be labeled with the same reference numbers.

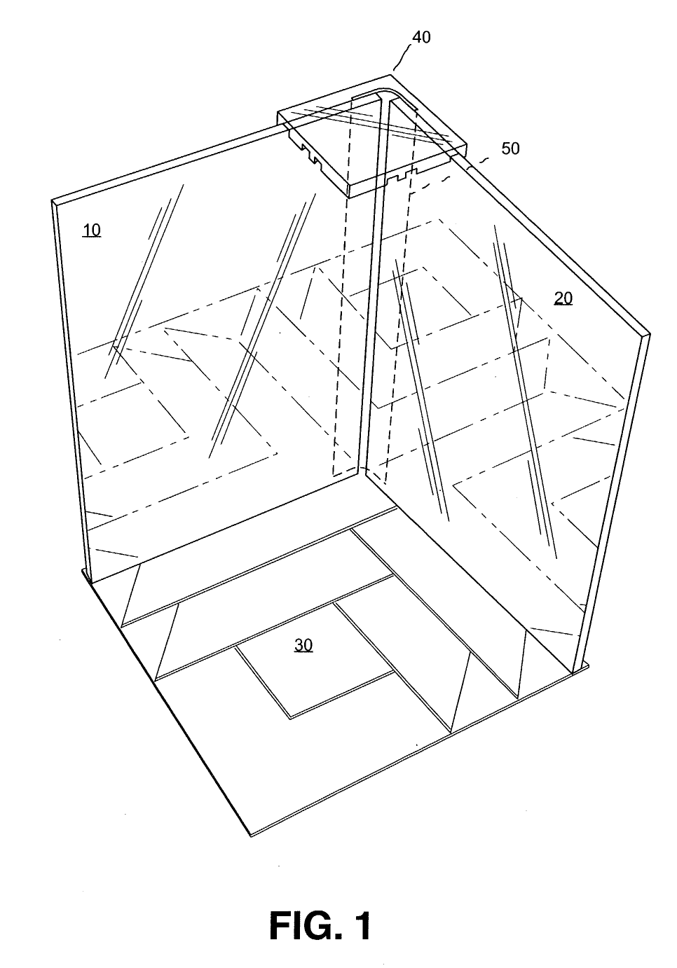

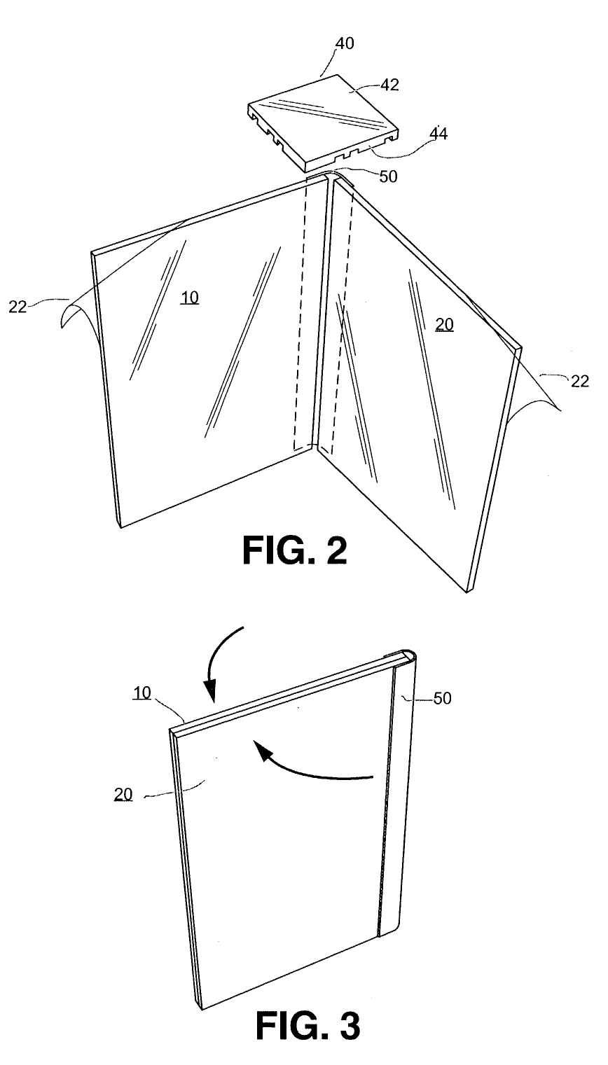

As seen in reference to FIGS. 1 and 2, a first mirror 10 and a second mirror 20 are provided and which are joined by a hinge 50 seen here in the form of an adhesive, flexible film. As seen in FIG. 2, a removable protective film 22 may be present which protects the mirrors 10 and 20 during handling. The hinged mirrors as seen in FIG. 1 are positioned at a 90° angle relative to the included angle formed by the reflective surfaces of mirrors 10 and 20. As best seen in reference to FIG. 1, positioned in front of the hinged mirrors is a fabric pattern 30 as illustrated by the multiple solid pattern lines. Fabric pattern 30 has dimensions which, in this example, correspond to the width of each base of mirrors 10 and 20 and which define the operative viewing area for the mirrors. As indicated by the dashed lines in the reflective surfaces of mirrors 10 and 20, three reflected images of pattern 30 are formed therein. The reflection, combined with the original pattern 30, permits one to preview a fabric/pattern motif of four repeating units prior to cutting and assembling additional fabric.

By decreasing the size of the included angle, i.e., to one less than 90°, the number of reflections are increased, changing the reflected image into one having a greater number of repeating patterns. As a result, using an initial pattern template, one can view a design or pattern block to visualize how the repeating blocks will appear when joined on the finished fabric such as a quilt.

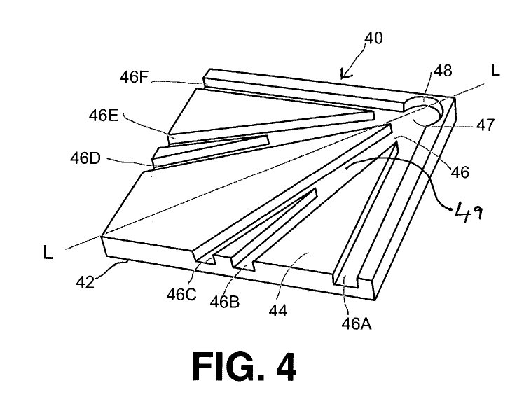

To facilitate the use of hinged mirrors for design previews, it has been found useful in accordance with this invention to provide a mirror gauge 40. As seen in reference to FIGS. 1, 2, and 4, mirror gauge 40 may be in the form of a rectangular template. In the illustrated embodiment, and as best seen in reference to FIGS. 2 and 4, gauge 40 defines a flat planar surface 42 and an opposing surface 44. Surface 44 defines a plurality of receiving areas seen here in the form of channels 46 which are individually referenced in FIG. 4 as channels 46A through 46F. As seen in FIG. 4, channels 46A through 46F overlap along a common intersection point or vertex 47 within a corner of gauge 40. As seen in FIG. 4, the vertex 47 of the intersecting channels 46A through 46F may be co-extensive with an opening 48 seen here in the form of an arcuate-shaped excision. Opening 48 is co-extensive with and in communication with each of the respective channels 46A through 46E along the vertex 47. As explained below, the arcuate-shaped opening 48 facilitates the placement and adjustment of mirrors engaged along the respective channels 46.

As best seen in reference to FIG. 4, certain channels such as 46B and 46C may be co-extensive over a common portion 49. The width of each channel 46 may be varied as needed to accommodate the edge thickness of an associated mirror. As such, the relative size of common portion 49 may also vary.

As best seen in reference to FIG. 4, channels 46A and 46F collectively define therebetween a 90° included angle. Channels 46C and 46D define a 45° included angle, while channels 46B and 46E define a 60° angle. In each instance, the 45° and 60° angles referenced above are positioned within the gauge 40 such that each respective angle bisects the 90° included angle. In other words, the included 90°, 60°, and 45° angles defined above are each bisected by a common reference line L-L which extends diagonally along gauge 40 as seen in FIG. 4. In this manner, the viewing position and orientation of a user does not change as the mirror viewing angle is varied, thereby facilitating use of the mirror gauge. While the descriptions herein are in reference to commonly used angles of 90, 60, and 45° degrees, it is understood that any desired viewing angle may be provided by any two channels 46 which are bisected by common reference line L-L.

As best seen in reference to FIGS. 1 and 2, the hinged mirrors 10 and 20 are engaged along respective upper edges of the mirrors by the respective channels 46. The mirror edges, once placed within the respective channels, support the gauge 40. Similarly, gauge 40 maintains the mirror in the desired viewing angle, allowing the user to position and modify viewed pattern pieces 30.

The mirror gauge also facilitates the repositioning of the mirrors. To reposition the mirrors, the user applies a slight compressive force downwardly upon the mirror gauge while lifting the hinged mirrors. The hinged mirrors and mirror gauge can then be repositioned along another location for the viewing of a different pattern within the operative viewing area found between mirrors 10 and 20. The opening 48 allows the distance between the hinged edges of the mirrors to be adjusted to fine tune an appropriate mirror viewing position.

One having ordinary skill in the art will readily appreciate that the size of pattern pieces being viewed may be smaller than the full size pattern piece 30 seen in FIG. 1. The use of the mirror gauge allows one to preview patterns based upon geometrically repeating units. When viewed at a 90° angle, the single pattern is visualized as one-fourth of a four-unit pattern. Upon decreasing the angle to 60° or 45°, the number of repeating units increases. By adopting standard angles of 90°, 60°. and 45°, the gauge and mirrors facilitate the use of pattern pieces using widely available templates and pattern piece options.

While the illustrated embodiment is seen in reference to a rectangular piece of clear transparent plastic, the mirror gauge may be provided from a wide variety of materials. For instance, the necessary channels may be formed in structures having shapes other than a rectangle. Similarly, any solid material capable of having the necessary channels formed therein may be used including plastics, wood, metal, ceramic, or nylon, as well as other moldable substrates or solid materials which may be cut so as to achieve the necessary channels.

The surface 44 as described in reference to the illustrated embodiment seen in FIG. 4, has receiving areas in the form of channels 46. As seen in reference to channels 46E and 46F, the respective edge walls which define the channels may extend from the vertex 47 to an opposite edge of the template.

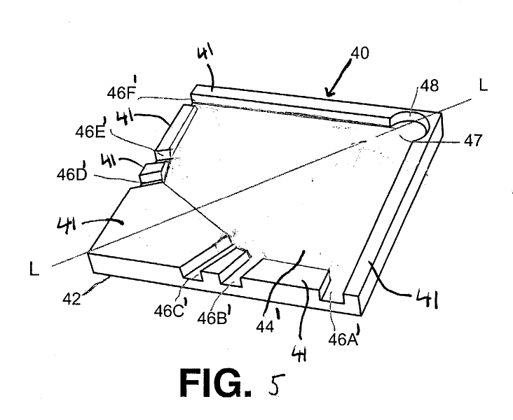

In an alternative embodiment of the mirror gauge 40, seen in reference to FIG. 5, a substantially flat surface 44 of gauge 40 supports a series of elevated edge members seen here in the form of variously shaped polyhedral segments 41. Gaps, seen in reference to specific gaps 46A′ through 46F′, are defined between adjacent segments 41, the respective gaps corresponding to a region through which an edge of a mirror may be received. In the illustrated embodiment of FIG. 5, gaps 46A′ and 46F′ are adapted for receiving and positioning a hinged mirror at a 90° angle. Gaps 46B′ and 46E′ are adapted for receiving and positioning a hinged mirror in a 60° angle, while gaps 46C′ and 46D′ are similarly adapted for receiving a hinged mirror at a 45° angle.

As is readily appreciated by one having ordinary skill in the art, suitable edge members may take on a variety of forms and shapes while providing an appropriate positioning structure for engaging a corresponding mirror. At a minimum, a mirror should be positionable against at least one edge member wall which provides the necessary orientation for establishing and maintaining the desired mirror angle.

For instance, instead of polyhedral segments 41, a suitable engaging edge wall could be provided by an elevated circular post extending from surface 44′. Preferably, at least two edge wall members are positioned on opposite sides of the engaged mirror. However, the edge members need not be immediately adjacent or in close proximity to one another, but may be positioned some distance from one another so long as one edge member is positioned along an opposite side of the mirror from the other so as to define therebetween an intermediate gap.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged, both in whole or in part. Therefore, the spirit and scope of the appended claims should not be limited to the description of the preferred versions contained therein.

That which is claimed is:

1. A gauge for holding two mirror surfaces at a desired angle comprising:
a template having a surface defining a plurality of channels, a first channel and a second channel intersecting to form an angle, each of said channels adapted for receiving a respective portion of an edge of a mirror therein, thereby positioning said hinged mirror at said angle.

2. The gauge according to claim 1 wherein said first channel and said second channel form a 90 degree included angle.

3. The gauge according to claim 2 wherein said surface further defines a third channel and a fourth channel, said third channel and said fourth channel forming a 60 degree included angle.

4. The gauge according to claim 2 wherein said surface further defines a pair of channels forming a 45 degree included angle.

5. The gauge according to claim 3 wherein said surface further defines a fifth channel and a sixth channel, said fifth channel and said sixth channel forming a 45 degree included angle.

6. The gauge according to claim 3 wherein said 60 degree included angle bisects said 90 degree included angle.

7. The gauge according to claim 5 wherein said 45 degree included angle and said 60 degree included angle bisect said 90 degree included angle.

8. The gauge according to claim 1 wherein said plurality of channels define a depth which is substantially constant along the length of each said channel.

9. The gauge according to claim 1 wherein said template is transparent.

10. The gauge according to claim 1 wherein said plurality of channels further defines a single vertex at a common point of intersection.

11. The gauge according to claim 10 wherein said gauge defines an opening co-extensive with said vertex.

12. A process of visualizing a repeated pattern based upon reflected images of a single pattern piece comprising:
supplying a pair of mirrors;
placing said mirrors on a respective edge;
engaging a top edge of each mirror with a mirror gauge, said mirror gauge comprising a template having a surface defining a plurality of channels, a first channel and a second channel intersecting to form an angle, said first channel and said second channel adapted for engaging a respective edge of a hinged mirror, thereby positioning said hinged mirror at said angle;
placing a pattern piece within an operative viewing area of said pair of mirrors;
wherein said pattern piece is reflected within said pair of mirrors, thereby forming a visible, repeating pattern.

13. The process according to claim 12 comprising the additional step of varying said angle of said mirrors, thereby changing the visible, repeated pattern.

14. The process according to claim 13 wherein said step of changing said angle includes the step of removing said gauge from said mirrors and repositioning said mirrors to engage a different pair of channels from said plurality of channels.

15. A gauge for holding two mirror surfaces at a desired angle comprising:
a template having a surface defining a plurality of edge members, said plurality of edge members further defining a plurality of gaps therebetween, each of said gaps adapted for receiving a respective edge portion of a mirror therethrough, thereby positioning said mirrors at an angle.

16. The gauge according to claim 15 wherein said edge members are polyhedrons.

17. A combination mirror and gauge assembly comprising:
a first mirror;
a second mirror;
a mirror gauge for holding said first mirror and said second mirror at a desired angle, said mirror gauge comprising a template having a surface defining a plurality of edge members, opposite edge members further defining a gap therebetween, each of said gaps adapted for receiving a respective edge portion of a mirror therein, thereby positioning said mirrors at said desired angle.
